(19) United States
(12) Patent Application Publication
(10) Pub. No.: US 2009/0138964 A1
(43) Pub. Date: May 28, 2009

(54) Subscriber management system

(75) Inventors: Kevin P. Headings, Hermosa Beach, CA (US); Justin W Heymanson, Marina Del Rey, CA (US); Samuel J. Beckman, Thousand Oaks, CA (US)

Correspondence Address: MARTIN & FERRARO, LLP, 1557 LAKE O'PINES STREET, NE, HARTVILLE, OH, 44632, US

(73) Assignee: Intertainer Inc.

(21) Appl. No.: 12/321,796

(22) Filed: Jan. 26, 2009

Related U.S. Application Data
(63) Continuation of application No. 09/921,107, filed on Jul. 31, 2001.
(60) Provisional application No. 60/280,664, filed on Mar. 30, 2001.

(51) Int. Cl. G06F 21/00; G06Q 30/00

(52) U.S. Cl. 726/17; 705/1

(57) ABSTRACT

The present invention is directed to a system and methods for creating and maintaining subscriber accounts to access digital media content. In one preferred embodiment, accounts and sub-accounts are created with access restrictions being selectively imposed among the accounts and sub-accounts. When the accounts are used to gain access to digital media content (e.g., video on demand), such restrictions may take the form of spending limits, viewing content, and viewing times. In another preferred embodiment, the spending of each account is tracked and a debit posted upon the first occurrence of either the account attaining a selected spending limit, or a selected interval of time elapsing. In another embodiment, account holders are grouped based on a shared characteristic. Targeted marketing is then presented to the group based on the shared characteristic.

### RELATED APPLICATION

This application is a continuation of U.S. application Ser. No. 09/921,107, filed Jul. 31, 2001; which claims the benefit of U.S. Provisional Application No. 60/280,664, filed Mar. 30, 2001; of which are incorporated by reference herein.

### BACKGROUND OF THE INVENTION

The digitization of media content (e.g., movies, music videos, educational content, television shows, games, live events, advertising, literary works, audio programs, and other media assets) is becoming more and more common with the advent of technology that allows content suppliers to derive revenues from these assets in a digital marketplace. “Content suppliers” may include entities that own the content, have rights to the content, or are otherwise suppliers of the media assets. There is a cost for entry into the digital space that requires infrastructure and processes to effectively distribute various forms of media assets to subscribers over a network (e.g., digital cable, Internet protocol, and satellite) and manage information collected from subscribers. For purposes hereof, “subscribers” may be commercial entities, such as hotels, or non-commercial entities, such as individuals or households. Content suppliers are not traditionally equipped to handle the foregoing requirements and would benefit from a system that minimizes the barrier to entry into the digital marketplace.

Users of content also have barriers in the digital marketplace. For purposes hereof, a “content user” is any person or entity that sells or otherwise exploits media assets to other content users or directly to subscribers. A content user may be, for example, the content supplier, a digital services platform operator, an online site builder, an educational institution, or a retailer. One issue facing content users is that consumers have varying likes and dislikes with respect to entertainment. For example, a consumer in South Carolina may like car racing and cowboys movies, while a consumer in Utah may prefer rock music videos and kids programming. The challenge for content suppliers or content users is to recognize these likes and dislikes and recommend content to these users that reflect their unique tastes. This process requires collecting information from each subscriber and monitoring their use of content. For a system that provides entertainment services to many subscribers, this process can be difficult to manage effectively. In view of the foregoing, there is a need for a system that effectively manages information collected from subscribers to a digital media service, including how the subscribers use and interact with the service.

### SUMMARY OF THE INVENTION

The present invention is generally directed to a system and method for creating and maintaining subscriber accounts. Two types of accounts are preferred: a head-of-household (HoH) account (a main account) and one or more family member accounts (sub-accounts). The head-of-household (HoH) account is the primary account holder who preferably controls all activity in the account, including any sub-accounts. The present system may be used to group accounts into service groups (groups defined by provider and/or level of service) and publishing groups (groups defined by demographics and/or viewing preferences). The grouping of accounts into publishing groups facilitates targeting advertisements to a particular account member. Each account may have established therewith permissions which place limits or restrictions on, for example, the material viewed, the amount spent, or viewing times.

The present invention is also directed to the maintenance of subscriber accounts. One preferred method of maintaining an account includes a billing procedure that posts a bill if the total account amount due exceeds a predetermined value, or if an account timer has elapsed. The account timer measures the difference from the last occurrence that a bill was posted on the account and a new subscriber order. The present system may also be used to view account balances and limits, view an account-viewing history, issue return credit, and view financial transactions.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

FIG. 1 is a representational diagram of a subscriber management system consistent with a preferred embodiment of the present invention;

FIG. 2 is a relational schematic diagram of the account creation procedure in accordance with a preferred embodiment of the present invention;

FIG. 3 is a logic diagram of the preferred method for creating accounts of FIG. 2; and

FIG. 4 is a logic diagram of a preferred method for posting an amount due for a subscriber account.

### DESCRIPTION OF THE PREFERRED EMBODIMENTS

Reference will now be made in detail to the present preferred embodiments (exemplary embodiments) of the invention, examples of which are illustrated in the accompanying drawings.

The present invention is directed to a system and method that creates subscriber accounts and manages the accounts along with information relating to subscriber usage of content on a digital media service. The system supports multiple users and user groups as well as multiple and diverse subscriber accounts.

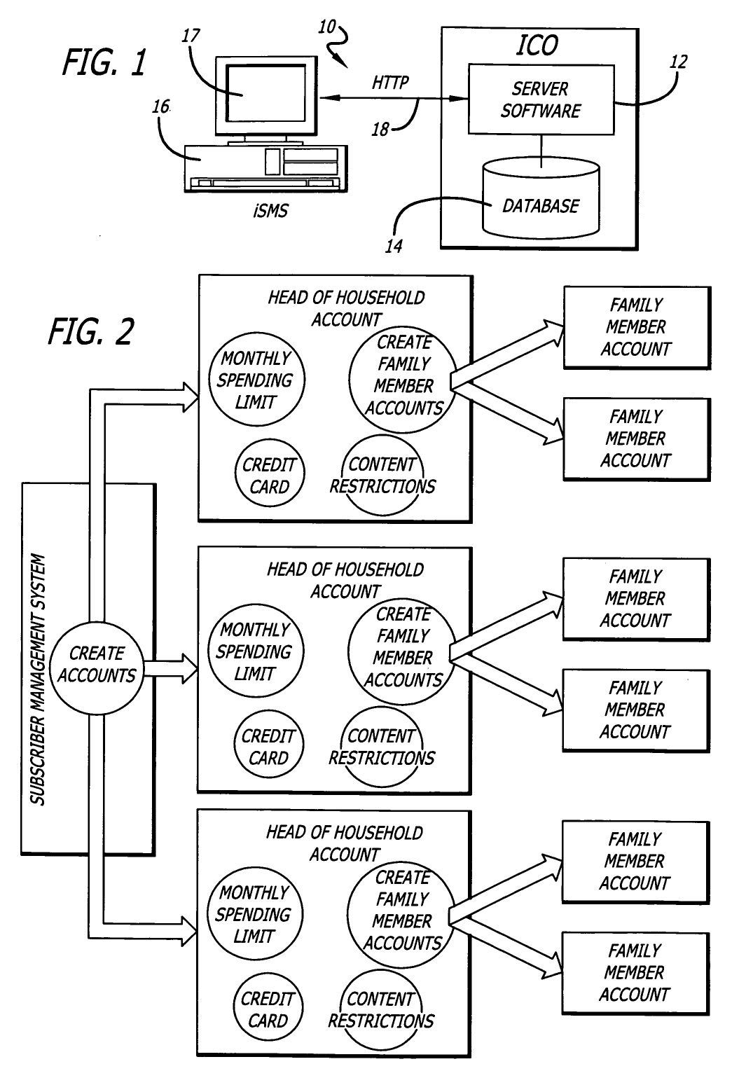

FIG. 1 illustrates a subscriber management system 10 consistent with a preferred embodiment of the present invention. Preferably, subscriber management system 10 is a software-based system that includes a server software 12, a database 14 (e.g., a relational database management system (RDBMS)), a computer 16, and client software 17, which preferably enables the subscriber management functions of the present invention. Computer 16 may communicate with server software 12 and database 14 over a local or wide area network (e.g., the Internet) through a communications channel 18 (e.g., HTTP). Communications channel 18 may be wire or wireless (e.g., cable, satellite, DSL, and wireless land-based systems such as cell phone technology). Client software 17 generates a graphical user interface to allow an operator (e.g., digital media service operator) to enter, modify, view or retrieve data stored in database 14 and create subscriber accounts. Subscriber management system 10 may operate as a stand-alone system or as part of a platform that offers multiple media-related services. Examples of preferred platforms operable with subscriber management system 10 are taught in U.S. application Ser. No. 60/280,653, titled “Digital Entertainment Service Platform,” and U.S. application Ser. No. (to be assigned), titled “Systems and Methods for Delivering Media Content,” filed Jul. 31, 2001, which claims priority to U.S. application Ser. No. 60/255,725, the disclosures of which are hereby incorporated by reference herein.

As shown in FIG. 2, a subscriber to a digital media service may set up a head-of-household (HoH) account using, for example, a graphical user interface that communicates with subscriber management system 10. Each HoH may set up family member accounts. A family member account is a sub-account that is controlled by the HoH. Preferably, the HoH will be responsible for the settlement of all family member accounts.

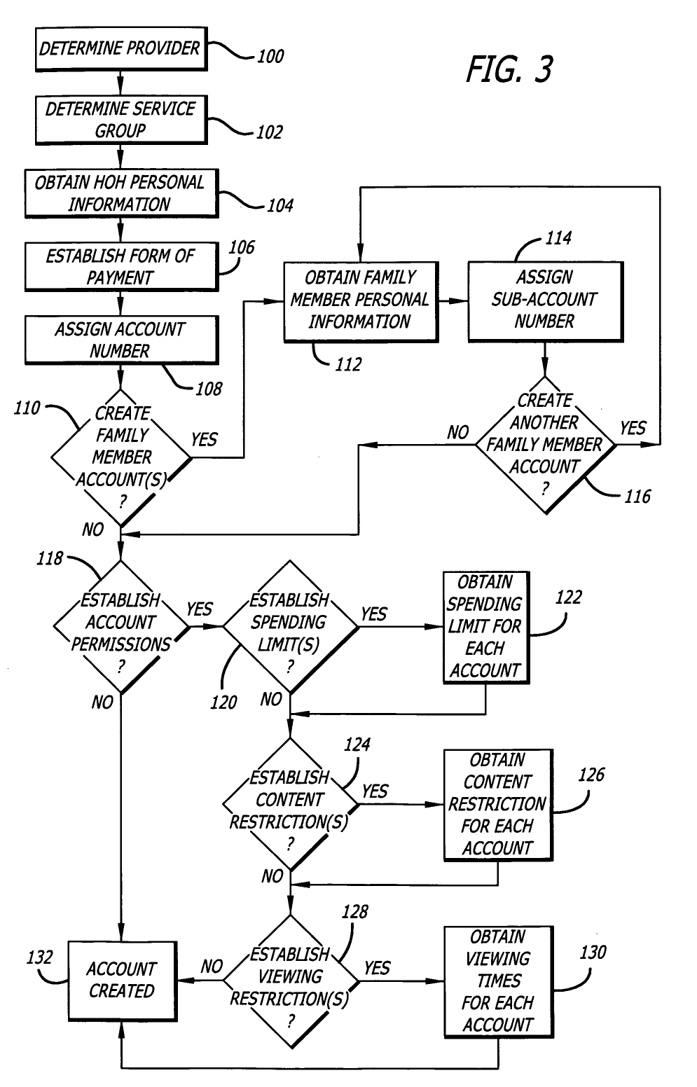

A preferred method for creating an account is shown in FIG. 3. In step 100, a digital media service provider is determined. A digital media service provider can be the entity from which the subscriber obtains their broadband access (e.g., digital subscriber line (DSL) provider or cable provider). In step 102, the service group is determined. A service group preferably includes subscribers with similar attributes, such as being assigned to a particular digital media service provider or having a certain level of service. A level of service may be defined, for example, by the subscriber's modem connection or service platform. Examples of service platforms include cable protocol (CP), Internet protocol (IP), hypertext transfer protocol (HTTP), file transfer protocol (FTP), wireless application protocol (WAP), digital subscriber line (DSL), real-time transfer protocol (RTTP), and any future developed protocols suitable for the intended purpose. Within some platforms, different levels of delivery may be made, for example, a 144K connection or 750K connection within a DSL platform.

In step 104, HoH personal information is obtained. Personal information preferably includes, for example, name, address, gender, age, and any viewing restrictions set by the HoH. In step 106, a form of payment is established. A preferred form of payment is via electronic transfer such as a credit card.

In step 108, an account number is assigned for each HOH account. In step 110, the HoH is queried as to whether one or more family accounts are to be created. If one or more family accounts are to be created, then in step 112, family member personal information is obtained similar to that information obtained in step 104. In step 114, sub-account numbers are assigned accordingly. In step 116, the HoH is queried as to whether another family member account is to be created. If another family member account is to be created, then steps 112 through 116 are repeated.

In step 118, the HoH is queried as to whether any account permissions are to be established. Account permissions place restrictions or limits on a subscriber account. If the HoH decides to establish an account permission, then in step 120 the HoH is queried as to whether any spending limits are to be established. If the HoH decides to establish spending limits, then in step 122 spending limit information for each account is obtained. Spending limits may be imposed upon the HoH account as a whole, or selectively amongst family member accounts and/or the HoH account. For example, a hard goods spending limit of $50.00 may be imposed on the entire HoH account, and/or a video spending limit of $10.00 may be imposed on one or more family member accounts. The spending limit may be imposed as an absolute value and/or a time-based value. For example, the aforementioned $50.00 may be on a per month basis, or other predetermined timeframe. If an absolute value is imposed on the account, account access may be denied until the HoH resets the spending limit or settles the account debt.

In step 124, the HoH is queried as to whether content restrictions are to be established. If the HoH decides to establish content restrictions, then in step 126, content restriction information is obtained for each account. Again, the restrictions may be imposed on the HoH account as a whole, or selectively amongst one or more family member accounts and/or the HoH account. Content restrictions may include restrictions to, for example, a genre such as movies, music, or television, a sub-genre such as kids television; a content classification such as adult; or a particular rating such as G, PG-13, R, or X.

In step 128, the HoH is queried as to whether any viewing restrictions are to be established. If the HoH decides to establish viewing restrictions, then in step 130 viewing times for each account are obtained. Viewing restrictions may be established for the HoH account as a whole, or selectively amongst family member accounts and/or the HoH account. The HoH may, for example, place a viewing restriction of only allowing PG or lower rated movies to be viewed on a particular family member. Alternatively, the HoH may place a time restriction on a sub-account, which permits viewing, for example, only between the hours of 6:00 p.m. to 10:00 p.m. Sunday through Thursday, and 6:00 a.m. to 11:00 p.m. Friday and Saturday on a particular family member.

As an example of using selective permissions amongst different family members, the HoH may impose a monthly spending limit of $45.00, restrict viewing of R-rated and Adult type movies and television shows for one family member account, while on a different family member account, imposing a higher spending limit, restricting access to PG-rated material, and imposing no time restrictions. Once all account creation and permission establishments have been addressed, then in step 132 the account creation is completed. The aforementioned method steps need not be performed in the particular order as just described. Many steps are interchangeable, or may be omitted altogether. For example, the establishment of a form of payment may be done before HoH personal information is obtained. Further, accounts may be created without opportunity to create family member accounts, or may be created without an option to establish account permissions. Other account permissions are envisioned and within the scope of the present invention.

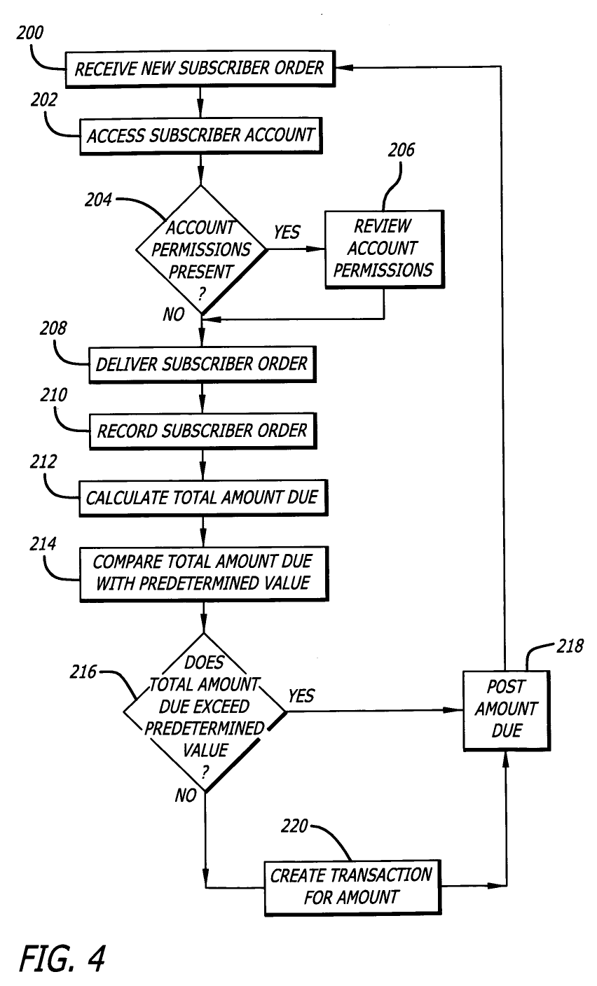

FIG. 4 shows a preferred method for settling a subscriber's account. In step 200, a new subscriber order is received. In step 202, the subscriber account is accessed. In step 204, it is determined whether there are any account permissions present. If account permissions are present, then in step 206 the account permissions are reviewed and content delivery will be based upon the permissions. In step 208, the subscriber order is delivered. In step 210, the subscriber order is recorded. In step 212, the system calculates the total amount due on the subscriber account. In step 214, the total amount due is compared with a predetermined value. If the total amount due exceeds the predetermined value in step 216, then the amount due is posted in step 218 using the subscriber's pre-selected form of payment, for example, a credit card. In addition, accounts may have a billing cycle. If the total amount due has not reached the predetermined spending limit set by the HOH account holder in a predetermined time frame (e.g., end of the billing cycle) then a transaction is created in step 220 for that amount and the amount due is posted using the subscriber's pre-selected form of payment in step 218. For example, the preferred billing procedure of the present invention may post a subscriber's total amount due to a credit card if the amount due exceeds $30.00, or if the account has gone more than 30 days without a bill posting.

The above steps need not be performed in the described order. For example, a subscriber's order may be recorded and billing determinations made before delivery of the subscriber order. Further, account permissions are not necessary if the subscriber does not desire any. The bill posting may be triggered by the occurrence of only a single event rather than multiple events.

The present system may also be used to update a subscriber account, change credit card information, view account limits and balances, view a video-on-demand history for each subscriber, issue a return, issue a credit, and view the subscriber's account and transactions therein. Additionally, financial reports may be generated. For example, a settlement report may be generated showing a subscriber's settlement history. If a subscriber is using a credit card as a preferred form of payment, the system may monitor the credit card posting and immediately close the account if the credit card fails.

Operations usage reports may also be generated. Such a report may provide information as to a subscriber's purchasing history. Content purchases for each individual account may be used to generate a viewing preference profile for that particular account. Such viewing preferences may be later used in combination with personal information demographics to target advertisements and content (e.g., horror movies) to the particular subscriber as will be described below.

Demographic information and viewing preferences are used to group subscribers into publishing groups. A publishing group is defined as a logical grouping of account users that are related to a specific provider. Placement of a subscriber in a particular publishing group may depend on factors, such as a person's age, gender, location, any permissions established during account set-up, and viewing preferences. The delineation of subscribers into publishing groups is especially beneficial for precision marketing. As used herein, the term “marketing” is intended to include the offering of media content, including advertisements, for delivery to a consumer. For example, precision marketing may be directed to different subscribers within the same household, as well as marketing based on the subscriber's gender and age. Therefore, an elderly family member might receive different marketing than a pre-school family member, even though both subscribers might reside at the same location. For example, a home across the river from another might receive different geographic advertising. An example of a preferred system and method of targeted marketing operable with the present invention is described in U.S. application Ser. No. 09/825,758, titled “Internet Protocol-based Interstitial Advertising,” the disclosure of which is hereby incorporated by reference herein.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for controlling access to digital media content, the system comprising:
a database for storing main accounts and sub-accounts required to access the digital media content, at least one of said main accounts being linked to at least one of said sub-accounts, said database including demographic information for a user of at least one of said main accounts and a user of at least one of said sub-accounts; and
a computer processor programmed to selectively restrict access to the digital media content by said main accounts and said sub-accounts, said computer processor being programmed to permit at least one of said main accounts to control access to the digital media content available to said at least one of said main accounts and one or more sub-accounts associated with said at least one of said main accounts, said computer processor being programmed to group users of the main accounts and users of the sub-accounts into at least one grouping of account users, the users in the at least one grouping having at least one demographic characteristic in common, said computer processor being programmed to make available the digital media content to at least one of said main accounts based on the grouping of the user of the at least one of said main accounts and to make available the digital media content to at least one of said sub-accounts based on the grouping of the user of the at least one of said sub-accounts.

2. The system of claim 1, wherein said processor restricts access to the digital media content according to selected spending limits.

3. The system of claim 2, wherein said spending limit is imposed on a time-based value.

4. The system of claim 1, wherein said processor restricts access to the digital media content according to a type of content.

5. The system of claim 4, wherein the type of content is based on a genre of at least one of video and audio media.

6. The system of claim 1, wherein said processor restricts access to the digital media content in accordance with a rating system.

7. The system of claim 1, wherein said processor restricts access to the digital media content according to viewing times.

8. The system of claim 1, wherein said processor is programmed to permit the user of at least one of said main accounts to selectively restrict access to at least one of said sub-accounts linked to the main account.

9. The system of claim 1, wherein said processor is adapted to generate a report of the spending habits of the users using the accounts.

10. The system of claim 1, wherein said processor is adapted to generate a report of the viewing habits of the users using the accounts.

11. The system of claim 1, wherein the digital media content is offered through a subscription service, the user of at least one of said main accounts and the user of at least one of said sub-accounts being a subscriber to said subscription service.

12. The system of claim 11, wherein said subscriber is a commercial entity.

13. A computer-implemented method for creating an account for an account holder to view digital media content, the method comprising:
creating a record for a primary account to permit a primary account holder to view the digital media content;
obtaining demographic information about the primary account holder;
creating a sub-account linked to the primary account to permit a sub-account holder to view digital media content;
obtaining demographic information about the sub-account holder;
selecting a form of payment;
imposing restrictions to access the digital media content to at least one of the primary account and the sub-account;
providing an option for the primary account to control access of the digital media content by the primary account and the sub-account linked to the primary account;
assigning an identifier to the primary account and the sub-account;
grouping primary account holders and sub-account holders into at least one grouping of account holders, the account holders in the at least one grouping having at least one demographic characteristic in common; and
making available the digital media content to the primary account based on the grouping of the primary account holder and making available the digital media content to the sub-account based on the grouping of the sub-account holder.

14. The method of claim 13, wherein said imposing restrictions includes imposing restrictions selectively among the primary account and the sub-account.

15. The method of claim 13, wherein said imposing restrictions on the sub-account is performed by the primary account holder.

16. The method of claim 13, wherein said imposing restrictions includes restricting the amount the primary account holder and the sub-account holder can spend.

17. The method of claim 13, wherein said imposing restrictions includes restricting the type of content accessible to the primary account holder and the sub-account holder.

18. The method of claim 13, wherein said imposing restrictions includes restricting the viewing times during which the primary account holder and the sub-account holder can view content.

19. The method of claim 13, wherein said imposing restrictions includes restricting the content accessible to the primary account holder and the sub-account holder based on a rating of the content.

20. The method of claim 13, further comprising generating a report of account activity.
